(19) United States
(12) Patent Application Publication
(10) Pub. No.: US 2011/0243796 A1
(43) Pub. Date: Oct. 6, 2011

(54) ARRANGEMENT FOR ACOUSTICAL PHASE CONVERSION

(75) Inventor: Bengt Ovelius, Hestra (SE)

(73) Assignee: PICOTERM AB, Solna (SE)

(21) Appl. No.: 13/130,922

(22) PCT Filed: Nov. 26, 2009
(86) PCT No.: PCT/SE2009/051342

§ 371 Date: May 24, 2011

(30) Foreign Application Priority Data
Nov. 27, 2008 (SE) 0850105-8

(51) Int. Cl. B06B 1/00

(52) U.S. Cl. 422/127

(57) ABSTRACT

A method and an arrangement for phase conversion. The arrangement has a space including a working gas and is arranged to include a generated standing sound wave, whereby said sound wave is generated such that the sum of added and consumed wave energy is greater than or equal to zero. Furthermore, the arrangement has a valve mechanism for provision and outflow of a quantity of a working gas or composition, including at least one substance, in the space and is arranged to work synchronously with the generated sound wave. The generated sound wave exposes the working gas or composition to pressure and temperature changes, whereby a gas compression creates an elevated temperature and a gas decompression creates a reduced temperature; and whereby a phase conversion, caused by the pressure and temperature changes, is obtained.

### TECHNICAL AREA

The present invention covers an arrangement for Acoustical Phase conversion.

### BACKGROUND OF INVENTION

It is known that a powerful sound wave shows a pressure swing and because a sound wave is always adiabatic, i.e. no heat is added or removed, there is always a temperature variation, which follows the pressure swing. This means that a high pressure gives a high temperature and that a low pressure gives a low temperature. The relation between temperature and pressure can be shown in other ways. One example is when one goes up a mountain, the temperature and pressure drop in approximately the same way and with a similar order of magnitude.

It is also known that rain clouds are created when warm air is forced upwards on a mountain and is cooled. In the same way a rain cloud can form in an acoustic sound wave. One difference is that the passage up a mountain takes a long time while a sound wave can offer 200 roundtrips per second up and down an equivalent 300 meter high mountain, all within a tube of small dimensions. Hence, different gases and vapors can condense within a tube under these conditions. Primarily, we are concerned with the extraction of water from air, but methane and carbon dioxide may be condensed using this technology, for example.

The density of air is approximately 1.33 kg/cubic meter at atmospheric pressure and this amount of air according to the diagram in FIG. 10 contains 4-30 grams of water. Favorable conditions to extract water exist in coastal areas of warm countries. If one supposes that the air in a coastal area has a temperature of 25 C and that the air is saturated directly over the ocean surface, then there is approximately 20 grams of water in 1.33 cubic meters of air. Desalination of sea water is very energy demanding, since the latent heat of evaporation is 2.27 Mega-joules/kg, which corresponds to 0.55 kilowatt hours/kg. To this one has to add the bond energy of salt to water. The theoretical value to separate water from 3.45% salt in sea water is 0.86 kilowatt hours/cubic meter.

Today, water is manufactured on a large scale by desalination of sea water using distillation or osmosis. The actual industrial manufacturing requires 5 to 30 times more energy than the theoretical value.

Natural gas from the oil fields consists of approximately 87% methane. Because methane is a very light gas it is hard to transport by boat or train. Where there is a pipeline the natural gas can be used, otherwise it will be burned off and wasted. If methane can be converted to a liquid form in an inexpensive way it would mean that far more methane from the oil fields can be used. Farmers have a large opportunity to manufacture methane from manure or other biological waste. A simple conversion to liquid form should mean that a single farm could increase its profits and produce carbon dioxide neutral fuel. Such an activity reduces the Greenhouse Effect in a powerful way, because methane leakage to the atmosphere is avoided.

In 1997, the first thermo-acoustic unit in the world was used to produce liquefied natural gas (LNG). This known thermo-acoustic unit contains a thermo-acoustic stack with a cold heat exchanger and a warm heat exchanger at either end of the stack. This thermo-acoustic unit is several storeys high and has a cooling effect of 2 kilowatts. It also uses helium as its cooling medium and 35% of the natural gas is used to drive the unit in a large burner at the top. Hence, only 65% of the gas is condensed to LNG.

In stack based thermo-acoustic systems the resonator tube contains a thermal stack composed of several small parallel channels or plates where pressure and speed variations through the stack are such that the heat is supplied to the oscillating gas at high pressure and removed at low pressure. Furthermore, the stack has a cold heat exchanger at one end, that is a heat exchanger from which the working gas absorbs heat and in the other end a warm heat exchanger, that is a heat exchanger to which the working gas delivers heat.

A disadvantage of stack based thermo-acoustic devices is that the stack must have a large surface area and be made from thin heat exchanging materials. The technology has been developed over decades without reaching reliability, especially where high temperatures and large pressure swings are involved. A further disadvantage with stack-based systems is that they often use hydrogen or helium as working media and it is a known problem that these gases have a tendency to dissipate even from apparently hermetically sealed systems. A third disadvantage is that the stack dampens the wave.

### SUMMARY OF THE INVENTION

The present invention comprises an arrangement and a method for phase change, where for example a liquid substance can be extracted from a gas. One such proposed arrangement according to the invention contains a volume which in turn contains a working gas and is arranged to contain a generated standing or traveling wave, where said wave is generated when the sum of the added useful and wasted energy is greater than or equal to zero. Furthermore, the arrangement is composed of a valve mechanism to add or take away an amount of a compound substance. The generated sound wave exposes the working gas and compound substance to a pressure and temperature change where a gas compression creates an elevated temperature and where a gas decompression creates a reduced temperature, and thereby the externally added amount of the compound substance in the form of particles, drops or gases, into the working gas will undergo a phase change. As an example a part of the added amount of gas can condense.

In some cases this compound substance can consist of a multiple compound or a simple element. The said compound substance can be in a gaseous, solid or liquid form. In certain cases said compound substance can comprise water vapor that can be phase condensed to water droplets. Said compound substance can be gaseous such as air, methane, carbon dioxide, butane or propane. Said compound substance can comprise water drops that can be phase converted to snow. Said compound substance can comprise a solid form such as snow that can be phase converted to water vapor.

In another embodiment of the invention the arrangement comprises a device to supply energy or a device to consume energy, arranged to add or consume acoustic wave energy in such a way that the overall sum of the added and consumed energy is greater or equal to zero.

In another embodiment the device to supply energy is a membrane, a piston device, an engine, a salt or a volume reduction.

In the embodiments a condensation or chemical reaction takes place in the volume whereby acoustical wave energy is added or consumed so that the overall sum of the added and consumed energy is greater or equal to zero.

The valve mechanism can be arranged to open a valve opening at a minimum pressure of the sound wave, whereby an amount of gas is introduced to the volume. Furthermore, the valve mechanism can be arranged to remove an amount of working gas and an amount of the introduced compound substance from the volume, when said first valve is opened.

In the embodiments the arrangement comprises an external chamber connected to the volume so that said valve mechanism is arranged to open a second valve at a maximum pressure of the sound wave, whereby a gas exchange will take place between the volume and the chamber and whereby the chamber reaches the same pressure as the volume, when the second valve is open and whereby a part of said introduced amount of the compound substance which is introduced into the chamber will condense or undergo a phase change in the chamber. In the case of condensation, the chamber may contain a catalyst, for example a salt, to speed up the condensation.

The valve mechanism can possess a stationary disc having a number of holes and a rotating disc also having a number of holes, whereby the valve mechanism is arranged to open when the holes of the rotating disc are co-incident with the holes of the stationary disc.

In the embodiments at least one of the holes in the rotating disc is an asymmetric hole. Furthermore, in the embodiments at least one of the holes in the stationary disc is an asymmetric hole.

It shall of course be understood that the valve mechanism can be a moveable flap over one of the said holes or other type of valve that is capable of regulating the inflow or outflow to or from the volume. The valve mechanism can be controlled mechanically, hydraulically or electrically. It shall however be understood that the valve mechanism can be opened without active control, for instance by a pressure difference. One example of such a valve mechanism is a flap valve. The valve mechanism can further consist of two valve parts that can be controlled in an independent or dependent manner to each other. The valve mechanism can possess a symmetrical or asymmetrical opening.

The embodiments further comprise a drive device and a drive rod arranged to rotate said rotating disc in relation to said stationary disc and said volume.

In the embodiments a second container is arranged in connection with the chamber via a vertical tube, so that the second container and the vertical tube and the chamber contain a condensate up to a level in the chamber. A distance D1 between the level in the chamber and the upper surface of the second container can be of the size one to 100 meters, preferably around 5 meters.

In the embodiments the resonator for the sound wave is of cylindrical form, funnel shaped, or has a spherical or toroidal shape. The resonator can have a variable diameter along its axis. In the embodiments the resonator has a separating plane whereby the resonator along its axis is divided in two parts, with the purpose of controlling and improving the compound substance and working gas flow.

Embodiments comprise the working fluid air and the compound substance introduced to the volume such as air, methane, carbon dioxide, butane or propane.

### BRIEF DESCRIPTION OF THE FIGURES

The present invention will be described more in detail with reference to the attached figures, in which;

FIG. 1 schematically shows how two waves V1 and V2 are reflected between two walls and create a standing wave V3;

FIG. 2 schematically shows the basic physics behind reflection in a tube with one wall at one end and an opening at the other end, where; FIG. 2A schematically shows a graph T for pressure and a graph S for the displacement of the gas molecules and;

FIG. 2B schematically shows the density distribution of the gas molecules in the tube;

FIG. 3 schematically shows an embodiment of an invention according an acoustic resonator device with a synchronous valve mechanism;

FIG. 4A-C schematically shows a different embodiment of an invention according arrangement including one acoustic resonator device with one or two valve mechanisms;

FIG. 5 schematically shows an embodiment of an invention according arrangement including a resonator device and a chamber;

FIG. 6 sequence S1 to S9 schematically shows the gas flow in an embodiment of a thermo-acoustic resonator device;

FIG. 7 schematically shows an embodiment of an invention according arrangement where an energy supplying unit is arranged at one end of the resonator;

FIG. 8 schematically show san embodiment of an invention according arrangement where an energy consuming unit is arranged at one end of the resonator device;

FIG. 9 schematically shows an embodiment of an invention according arrangement where an energy supplying unit is arranged at one of the resonator and an energy consuming unit is arranged at the other end of the resonator;

FIG. 10 schematically shows how much water saturated air contains at different temperatures;

FIG. 11 schematically shows an embodiment of an invention according arrangement with a resonator device, a container, and an energy adding unit;

FIG. 12 schematically shows an embodiment of an invention according arrangement with a resonator device, a container, and an energy consuming unit;

FIG. 13 schematically shows an embodiment of an invention according arrangement.

FIG. 14 schematically shows an embodiment of an invention according arrangement showing a longitudinally divided resonator intended for a controlled gas flow;

FIG. 15 further shows an embodiment of an invention according arrangement.

### DETAILED DESCRIPTION OF THE EMBODIMENTS OF THE INVENTION

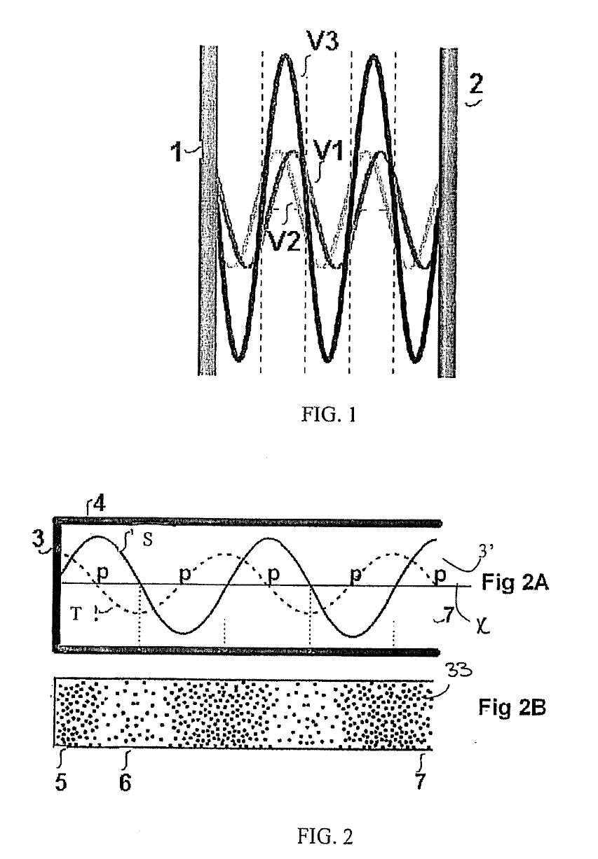

FIG. 1 shows two waves V1 and V2 and how they are reflected in a tube with two solid reflecting walls land 2. The first wave V1 that has an accommodated frequency travels to the left and is reflected by the wall 1, whereby the second wave V2 is created from the reflection. The two waves V1 and V2 are thus traveling in different directions, and at certain frequencies wave V1 and V2 interact and create a so called standing wave V3 with so called nodes and antinodes that are stationary. The amplitude for the standing wave V3 equals the sum of the amplitudes V1 and V2. As the energy cannot escape, very high amplitudes can build up with little added power.

In FIG. 2, the basic physics behind reflection in a tube 4 with a wall 3 and an opening 3′ is schematically shown. In FIG. 2 a curve T for pressure variations within a tube is schematically shown and a curve S for displacement of the gas molecules, for example air molecules, that are displacing in the X direction in a tube 4 is also shown. Closest to wall 3 the displacements are not possible and the curve S=0, while the pressure variation T is at a maximum. At the opposite end the contrary situation exists, where the displacement S is at a maximum at the opening 7 and the pressure T is constant. As shown the largest pressure swings take place at the wall 3, while there are points P, nodes, in a tube 4 that always have constant pressure. In the same way, points exist where no displacement of gas molecules occurs. As shown at points 5 and 6 in FIG. 2B a high pressure causes a dense gas and a lower pressure a less dense gas.

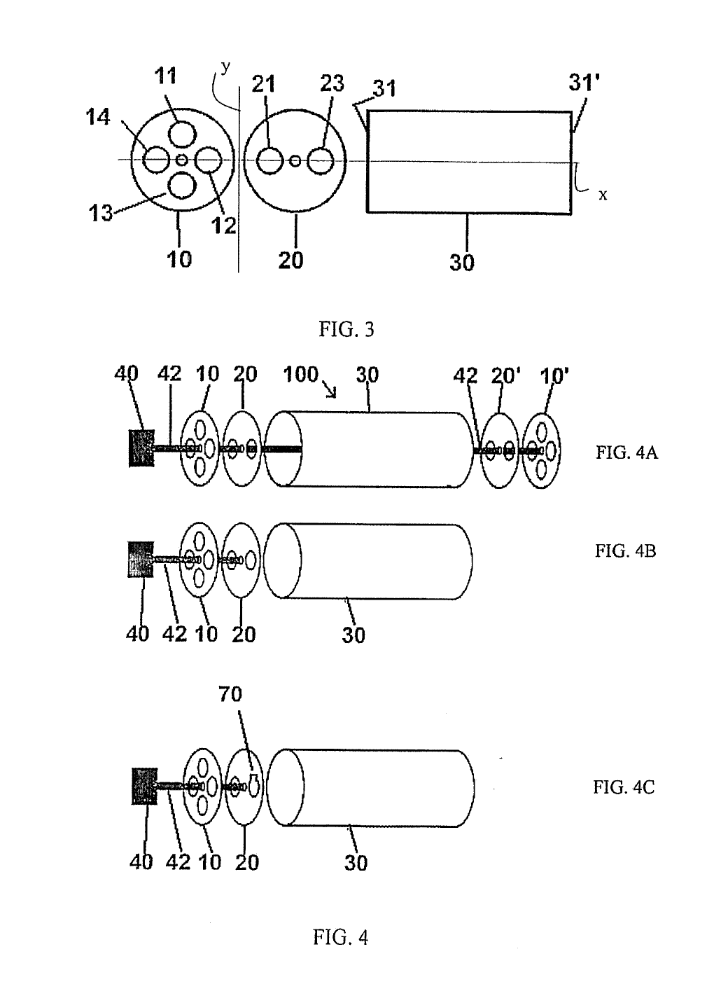

The present invention intends a method and an arrangement for acoustic phase conversion. As is schematically shown in FIGS. 3. and 4, one embodiment of the invention according arrangement 100, a space 30, also called a resonator device 30, for a standing sound wave or a traveling sound wave and a valve mechanism 10, 20 that works synchronously with the pressure variations of the sound wave. The resonator device 30 includes a certain amount of a working medium 33, also called working gas, for example a certain amount of air, but the working gas can also include another gas like nitrogen.

In the embodiments the resonator device 30 is arranged so that the X-displacement of the molecules S has an anti-node and two nodes, preferably a node at each end of the resonator device. It shall be understood that the resonator device can be dimensioned such that the soundwave in the resonator device has several entire wavelengths or half wavelengths so that the number of nodes and anti-nodes can vary.

It shall be understood that the resonator device 30 can have different shapes, for example spherical or cylindrical, but it can also be shaped as a toroid, that is, formed as an inflated tire. The resonator device 30 can have a diameter that varies along the X direction of the resonator device 30, that is, the resonator device 30 can for example be funnel shaped or conical.

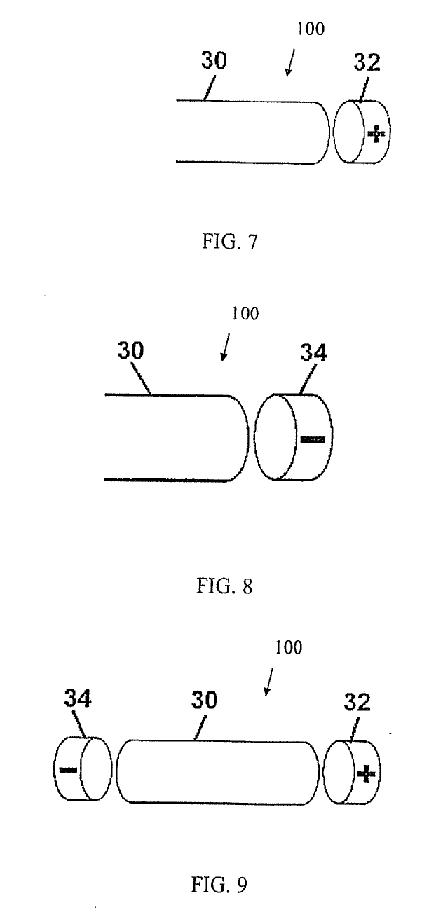

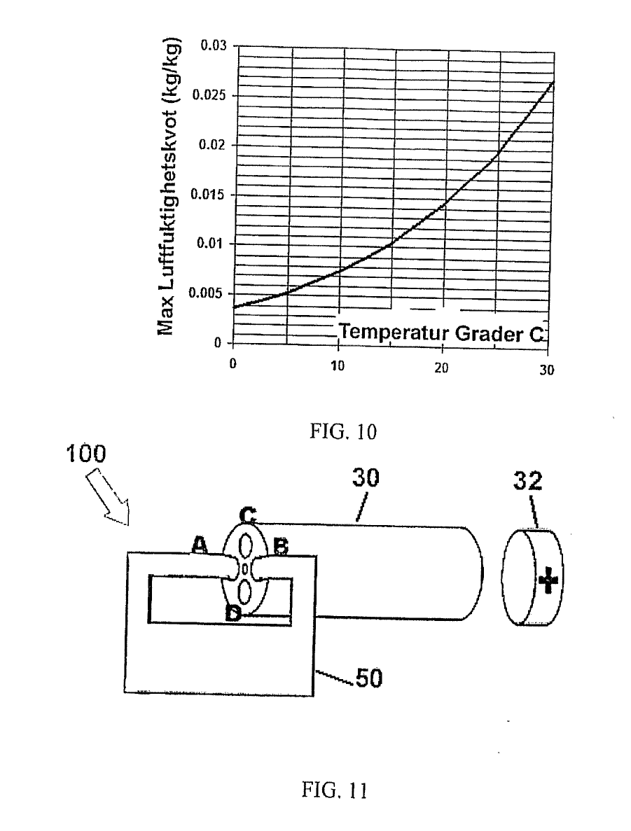

The embodiments of the arrangement 100 according to the invention have in addition an energy adding device 32, also called an energy adding unit 32, arranged to generate an acoustical wave in the space 30. These are shown for example FIGS. 7,9,11,13,15. The energy adding unit 32 can be shaped as a back and forth movable membrane 32 to create a standing wave with a resonance frequency within the space 30. The energy adding unit 32 can for example also be a piston arrangement, an engine, a salt or a volume reduction, which will cause a wave to be generated and which will be described below.

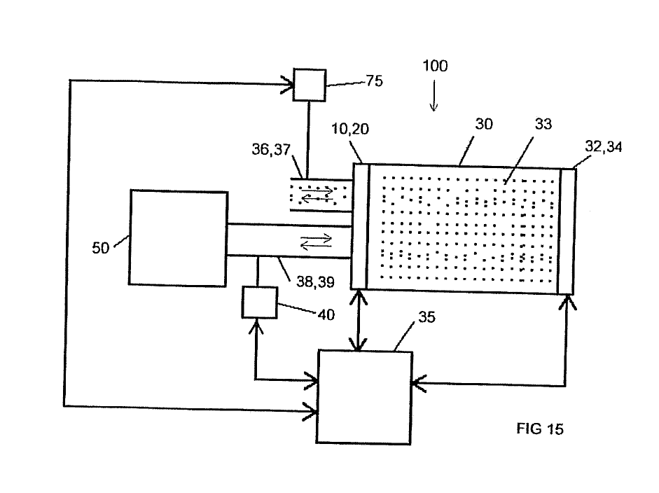

The embodiments of the arrangement according to the invention contain further a control device 35, as shown in FIG. 15, arranged to control the energy adding unit 32 and/or the valve mechanism 10,20. The control arrangement 35 can for example be a computerized unit, for example a microprocessor, arranged in connection with the energy adding unit 32 and valve mechanism 10,20. One task for the control device is to synchronize the soundwave and the energy adding unit and/or the valve mechanism. Control and synchronization can also be entirely mechanical. In the embodiments the valve mechanism can also be driven directly from the energy adding units, for example via a rotating rod.

Reflections at the ends of the resonator device 30 can take place via a closed or open end, for example a wall or in a open end, an opening through a diameter change.

In the embodiments the valve mechanism 10,20 is placed where the pressure variations are at a maximum, that is, by a closed or open end of the resonator device 30. Valve mechanism 10,20 can be arranged axially, as shown for example in FIGS. 3 and 4, or radially.

The valve mechanism 10,20 can be attached to a first end 31, a second end 31 or to both ends 31,31 of the resonator device 30, depending on the function or goal. Preferably the valve mechanism 10, 20 is attached to one end of the resonator device 30, in the embodiments where an energy adding unit, for example a piston or a membrane, is placed at the other end. The valve mechanism 10,20,10′,20′ may be arranged at both ends of the resonator device 30 in the embodiments, where for example an engine functionality is desired at one end and a condensation of liquid at the other end, that is consumption of energy from the wave in the other end. The driving rod 42 that is assembled straight through the resonator device 30 will not interfere with the standing wave, as the rod is aligned in the same axis as the wave.

In the embodiments the resonator device 30 has a stationary disc 10 and a rotating disc 20 in a first end 31 and a reflecting wall 31′ in the other end, as for example in FIG. 3. The rotating disc 20 is arranged to rotate at, for example 1000-100,000 rotations per minute (RPM), preferably faster than 4000 RPM.

In FIGS. 3 and 4 and an embodiment of the arrangement 100 according to the invention consisting of an axial valve mechanism 10,20 the valve mechanism 10,20 is placed in a first end 31 of the resonator device 30. As is shown in FIGS. 3 and 4, the valve mechanism 10, 20 is composed of a rotating disc 20 with a center hole for the driving rod 42. The drive mechanism 40 is arranged in connection with the control device 35 and arranged to rotate the disc 20, whereby the valve mechanism 10,20 is opened when the hole 21,22 coincide with one or several of the holes 11,12, 13,14 of the disc 10. Preferably the valve mechanism 10,20 is a synchronous valve mechanism, that is, it is arranged to open and close synchronously with the pressure variations in the resonator device 30. The valve mechanism is preferably arranged in pairs, whereby one pair opens at a pressure maximum of the sound wave and another pair opens at a pressure minimum.

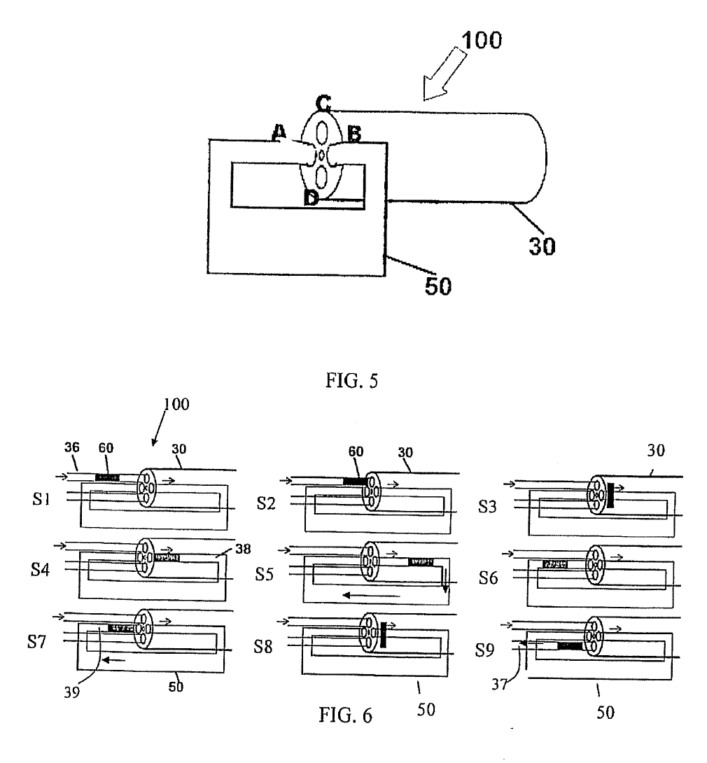

As is schematically shown in FIGS. 5 and 6, the holes 11,13 in the static disc 10 are arranged to create a connection between the resonator device 30 and the atmosphere, or between the resonator device 30 and a bidirectional pipe 36,37, when these holes 11,13 coincide with the holes 21,23 in the rotating disc 20. Furthermore, the holes 12,14 in the static disc 10 are arranged to create a connection 38,39, between the resonator device 30 and the container 50 when these holes coincide with the holes 21,23 in the rotating disc 20.

For example a supply pipe 36 to the resonator device 30 and a drain pipe from the resonator device 30 open up when the holes 21,23 of the rotating disc 20 are situated in a vertical position and correspond to the holes 11,13 of the static disc 10, whereby the valve mechanism 10,20 through the holes 11,13,21,23 is open. Further the connections 38,39 from the resonator device 30 to and from the container 50 are open when the holes 21,23 of the rotating disc 20 are situated in a horizontal position and correspond to the holes 12,14 of the static disc 10.

The number of holes 21,23 of the rotating disc 20 can be for example two and be round or pie shaped (triangular). It shall be understood that the number of holes can vary and that the holes can have other shapes. One or several of the holes can have an irregular shape. In FIG. 4C, the embodiment of a valve disc 20 with a hole 70 that has an irregular shape is shown, thus providing a better gas flow.

The static disc 10 has preferably a reflecting surface, mounted in such a way that it cannot rotate and in such a way that the rotating disc 20 is positioned between the static disc 10 and the one end 30 of the resonator device.

The static disc 10 has a number of holes 11,12,13,14, for example four holes. The holes may be round or pie shaped (triangular). In the embodiments the holes have a shape corresponding to the holes in the rotating disc. For example the holes can have an irregular asymmetric shape corresponding to a hole 70 in the rotating disc. It shall be understood that the number of holes can very depending on for example the number of desired supply pipes and drain pipes and that the holes can have other shapes, even asymmetric shapes. Furthermore a different pattern having a large number of holes can constitute an alternative valve mechanism, whereby the disc can rotate with considerably lower RPM.

Between the rotating disc 20 and the reflecting surface of the static disc 10 there is a friction reducing agent to reduce friction. Examples of a friction reducing agent are an oil, for example a thin oil film, or a very small and frictionless air gap. The size of the air gap can be constant and preferably the size of some micrometers. In the embodiments the rotating disc 20 is arranged to rest upon or hover on an air “cushion” or magnetic “cushion” with active or passive control to achieve the least possible air gap and thus a good seal between the static disc 10 and the rotating disc 20.

In the embodiments where the rotating valve disc 20 rests on an oil film, the rotation speed is preferably under or of the order of 10 m/s. In the embodiments where the rotation speed is higher than 10 m/s it may be to preferable to allow the valve disc 20 to hover on a magnetic “cushion” or air “cushion” (not shown) to minimize friction and to reduce friction down to almost zero.

In the embodiments with a short resonator device 30, that is where the length of the resonator along its X axis is shorter than for example 10 to 20 cm, the RPM become extremely high. As an example, it can be mentioned that a resonator device 30 with a length of 11 cm will have a valve disc 20 that rotates with approximately 44,000 RPM (rotations per minute), while a resonator arrangement with a length of 1 m requires a rotation of approximately 4800 RPM of the valve disc 20. Furthermore a resonator device 30 with a length of 4 m requires approximately 1200 RPM of the valve disc 20.

In FIG. 5, an embodiment of the invention is shown in which a container 50 is arranged with the resonator 30 via a valve mechanism 10,20. Preferably the container 50 has a pressure that differs from its surroundings, that is a pressure that differs from the air pressure in the atmosphere outside the container, to allow reactions enough time to take place. The pressure in the container 50 can hence be higher or lower than the air pressure in the atmosphere outside the container. When the valve pair A and B, that is holes 12,14,21,23 are open during a certain limited time period, the container 50 reaches the same pressure as the maximum pressure or minimum pressure in the resonator device 30, which leads to the fact that all processes that take place in the container 50 will be equivalent with the processes that take place in the resonator device 30 during that time frame and with the same pressure in the resonator device 30 and in the container 50. This means that if a liquid substance is extracted from the gas in the resonator device 30 then this liquid substance is also expected to be extracted from the gas in the container 50.

### Example 1

If a phase change from water vapor to water takes place in the resonator device during a pressure minimum, then the phase change in the container 50 equally takes place, that is a phase change from water vapor to water also takes place in the container 50.

An advantage of arranging a container 50 with the resonator device 30 is that the process has a longer time in which to occur. That means for example that a phase change becomes more complete, such that a larger portion of the liquid substance can be extracted from the gas compared with embodiments where the container 50 is not a part of the arrangement. In the resonator device 30 a phase change has only a few milliseconds in which to occur and it is easy to understand that the vapor cloud that appears at the minimum pressure may not have time enough to change to liquid droplets. With the container 50, the process has plenty of time to occur and it can be supported further by the influence of a catalyst. The catalyst's function is to facilitate the extraction of liquid substances and it can be salt crystals, a high-voltage, ultrasound, organic fibers or other measures. Organic fibers can be plant fibers such as those found in nature like cactus fiber or pine tree fiber. A catalyst is especially convenient in embodiments where a low temperature differential is desirable, as the catalyst can speed up extraction of the liquid substance despite a lower temperature differential.

A soundwave in the resonator device 30 has several properties like pressure, molecular movement, temperature and so on. By affecting some of these properties at the right moment the sound wave can be weakened or enhanced.

In embodiments of the invention a mixture of gases and vapors, liquid droplets and chemical substances and/or salts in powder form can be used. Usable energies exist bound in phase changes and the bonds between molecules and an acoustic resonator device 30 can interact with these energies in different ways.

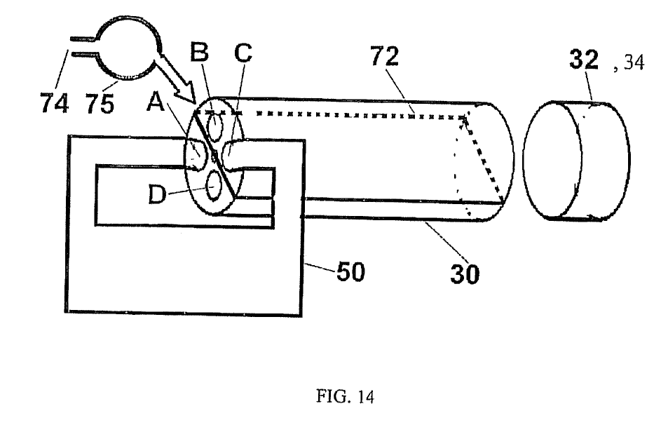

In FIG. 6, sequence S1-S9, describes schematically how the gas flow may look when it is transported to the resonator device 30 and into the container 50. In the embodiments there is a gas adding device 75, a source pipe 75 shown in FIGS. 14 and 15, arranged to supply a gas flow to the resonator device 30. The adding device 75 or the source pipe 75 can be arranged as a turbo or a fan whereby a gas is forced into a pipe or as a pump device whereby a gas is pumped or sucked into the pipe. Control device 35 can be arranged to control the source pipe 75, whereby the control device 35 can control the flow of gas to the resonator device 30.

As shown in sequence S1 gas is transported through a source pipe 36. It also can be created through suitably mounted gas adding device 75, for example fans or turbo unit, or through asymmetric shapes of the valves (not shown). In FIG. 6, the flow direction is shown with arrows. A certain amount of gas 60 is marked as a black rectangle in the pipe 36.

In the sequence S2 the amount of gas 60 approaches the valve mechanism 10,20 and in sequence S3 the said amount of gas 60 is situated in the resonator device 30. When the said amount of gas 60 is situated in the resonator device 30 the valve mechanism 10,20 is closed and the said amount of gas 60 is subject to pressure and volume changes through the influence of a soundwave, preferably a standing or traveling soundwave. In sequence S4, the valve mechanism 10, 20 to the container 50 is opened and in sequence S5 said amount of gas 60 moves in a pipe 38 towards the container 50, under a different pressure, temperature and volume compared with the conditions in sequence S1 and S2.

In sequence S6 and S7, when a reaction or a phase change has taken place in the container 50, said amount of gas 60 moves from the container 50 via a pipe 39 towards the valve mechanism 10,20. This can be done with a flow controlling device 40, for example a pump device or by creating a pressure differential as for example has been described above, by means of asymmetric openings. The control device 35 can further be arranged to control the flow controlling device 40, whereby the control device 35 can control the flow of gas between the resonator device 30 and the container 50.

In sequence S8, said amount of gas 60: is again situated in the resonator device 30 and the valve mechanism 10, 20 is closed. Everything repeats from the beginning. Under these circumstances, the sound wave and the original pressure from the beginning of sequence S1 is restored. In sequence S9 said amount of gas 60 exits the resonator device 30 via a drain pipe 37.

In FIG. 4C, an embodiment of a rotating valve disc 20 is schematically shown, that has at least one asymmetric hole 70. By using a rotating disc 20 with at least one asymmetric hole 70, it is possible to obtain a larger gas exchange than compared with the case where the rotating disc 20 has one or several symmetric holes. By the gas exchange, it is understood here that the gas situated in the space 30 swaps its position with the gas situated in the container 50. The more powerful the gas exchange is, a larger amount of the gas in the space 30 will swap its position with the gas in the container 50. In an alternative embodiment the asymmetric hole 70 may replace the two or four holes in the static disc 10.

The fact that the rotating disc 20 has one or more asymmetric holes 70, means that if for example a gas at atmospheric pressure (atm) that has been placed in the space 30 is exposed to a standing wave, the injected gas volume will be exposed to an increase in pressure and after a certain time of exposure in this space 30 the gas volume would have a pressure of for example 5 atm. This final pressure corresponds to the pressure in the container 50 (not shown in FIG. 4, but compare with FIGS. 5,6,11, 12,13 and 14). If valve mechanism 10, 20 with the asymmetric hole 70 opens a little bit before gas volume has reached 5 atm, the gas present in the container 50, due to the pressure differential between the pressure in the container 50 and that in the space 30, will flow from the container 50 to the space of 30, whereby the pressure in the container 50 will decrease. When the gas volume in space 30 reaches the desired pressure and the valve mechanism 10,20 becomes wide open, the gas, due to the pressure differential, will flow from the space 30 to the container 50.

In an arrangement in accordance with the invention with a thermo-acoustic resonator device, it is possible for vapor, liquid drops, salt in powder form or salt in liquid drops to interact to achieve different results. Salt in powder form and water vapor can for example be seen as a fuel for a thermo-acoustic engine. Salt in powder form can also be a fuel for a condensation process.

In embodiments of the invention the resonator device 30 has an energy adding device 32, as shown in FIG. 7. Examples of energy adding devices are:
An engine with various fuels, whereby the engine through a temperature increase at the moment when the wave is at its hottest, adds energy to the wave;
An engine for example with liquid air as fuel, whereby the engine through a temperature decrease at the moment when the wave is at its coldest, adds energy to the wave;
An engine that by a pressure increase when the wave is at is hottest, adds energy to the wave;
An engine that by a pressure decrease when the wave is at its coldest, adds energy to the wave;
An engine that by a volume decrease caused by phase change when the wave is at its coldest, adds energy to the wave;
An engine that by a volume increase caused by phase change when the wave is at its warmest, adds energy to the wave;
A valve that injects compressed air when the wave has its highest pressure, adds energy to the wave;
A salt in powder form or drops speeds up condensation of water vapor when is the wave is at its coldest. The salt can be seen as the fuel for the process:
A volume decrease that adds energy to the wave. A volume decrease occurs spontaneously when a large volume of water vapor collapses into a small water drop.

Hence it should be understood that the energy adding device can be a physical device, but it can also be a salt added to the space to speed up the process. The energy adding device can also be a spontaneous reaction like a spontaneous volume decrease in the space 30 when a large volume of water vapor collapses into small liquid drops, for example small water drops.

It shall further be understood that the energy adding device is only schematically shown in the figures.

In embodiments of the invention the resonator device 30 shows a energy consuming device 34 that consumes energy from the wave, as shown in FIG. 8. An example of an energy consuming device 34 is:
A refrigerator that causes a temperature increase when the wave is at its coldest, takes energy away from the wave;
A phase change, whereby small water droplets that freeze to ice when the wave is at its coldest, prevents a temperature swing downwards, hence taking energy from the wave;
A refrigerator that gives a temperature decrease when the wave is at its hottest takes energy from the wave;
A phase change, such as condensation of water, when the wave is at its coldest, the coldest molecules fall out first and make the surrounding air warmer, which in turn takes energy from the wave. The same phenomenon can be seen in nature where a cloud becomes slightly warmer when rain falls from it;
A piston or a membrane that works with a suitable frequency and phase, takes energy away from the wave;
A valve that adds compressed air with high pressure when the wave has the lowest pressure, takes energy away from the wave; or
A valve that takes away compressed air when the wave has the highest pressure, takes away energy from the wave.

In embodiments of the invention the resonator device 30 can have an energy adding device 32 and an energy consuming device 34, as shown in FIG. 9. Thus a multitude of combination possibilities for the many different requirements emerge.

Furthermore, one single unit may contain both an energy adding and an energy consuming device 32,34 at the same time. One example is condensation of water vapor, carried by air. Due to the fact that the partial vapor volume collapses when the pressure is minimal, the wave is strengthened. Due to the fact that the slowest molecules create the first drops, the remaining air thus becomes warmer when the wave is at its coldest, which weakens the wave. If the first effect dominates the acoustical wave in the resonator device will swing spontaneously. In another case an energy adding device 32 is arranged at the resonator device 30, whereby the energy adding device 32 provides the acoustic wave with the missing energy.

An advantage of extracting water directly from air is, that the sun has already done the energy demanding phase change from water vapor and separated the water from the salt of the ocean.

In FIG. 11, an acoustical resonator device 30 with a energy adding unit 32 is shown, where a container 50 is connected to the resonator device 30. Suppose that one square meter per second of air is passing the openings C and D in the valve mechanism 10,20 when these are open at a pressure maximum in the resonator device 30, the same amount of air is forced to pass through the openings A and B at a pressure minimum. If all the humidity is precipitated in the container 50, then it corresponds 250 g per second or 1.3 metric tons of water during 24 hours. The container then has a lower pressure.

In FIG. 13, an embodiment of the arrangement 100 according to the invention is shown, where the resonator device 30 and the container 50 are arranged at a distance M from the ground. For example, the container 50 can be arranged in such a way that a distance D1 between the liquid surface 80 in the container 50 and the surface of the other container 82 is in the range of 1 to 100 meters. In embodiments the distance D1 is about 5 meters

In embodiments of the invention the resonator arrangement 30 and the container 50 are arranged at a the distance M from the ground with a pipe 81, whereby for example liquid substance 84 from the container 50 can be transported down towards the ground M. As is schematically illustrated in FIG. 13 the pipe 81 and the container 50 contain the liquid substance 84, the container 50 contains the liquid substance 84 up to a level 80.

Furthermore, embodiments of the arrangement 100 according of the invention can have a second container 82 arranged at pipe 81 and for example placed on the ground M. The second container 82 can have a tap 83 with which the volume of the extracted liquid substance 84 can be tapped from the container 82 under positive pressure, while maintaining the lower pressure in container 50.

It should be understood the a tap or tap arrangement can be attached at the pipe or tube 81 in an embodiment that for example is missing the second container 82 or as a complement to the tap device 83 attached to the second container 82.

The pipe or tube 81 has such dimensions that it creates atmospheric pressure or higher at the lowest end of the tube. Thus, the liquid substance can be tapped without affecting the lower pressure in the container 50.

To maintain the standing wave for example, an energy adding unit 32 can be placed at one end of the resonator device 30, as shown in FIG. 11. This energy adding unit can be a piston or a valve mechanism that adds acoustic energy to the wave by pulsing compressed air, such as to supply alternating high and low pressure, or to pulse warm air, that is to supply alternating warm and cold air. The valve mechanism becomes the compressed air engine or a heat engine.

It shall be understood that according to the description above, natural gas can be transformed to liquid natural gas. With this invention a number of other gases including air, can be condensed, for instance CO2, butane and propane.

With reference to FIG. 11 for example, a gas containing methane can be injected into the resonator device 30 via inlets C and D, that open when the standing or traveling wave has a maximum pressure. In the resonator device 30, that injected gas will be exposed to a decreasing pressure, and at a certain, lower pressure, the openings A and B to the container 50 will be opened. The methane gas will condense in the container 50 at approximately minus 160 C. The injected gas to inlets C and D should have a higher pressure and be as cold as possible to allow a moderate wave pressure amplitude, to reach below minus 160 C. A rule of thumb can be to avoid a pressure swing greater than 40% of the static pressure. By increasing the static pressure, a greater pressure swing can be achieved. Thus lower temperatures can be achieved in the same step. By combining high-pressure and low-temperature on the injected gas, even lower temperatures can be reached at a pressure minimum.

In other embodiments the temperature can be taken down several steps, whereby different gases may condense. When processing natural gas, one may extract water in a first step, butane in the second step, methane in the third step and CO2 in a fourth step.

The injected gas can be mixed with a cooling agent, for instance air, nitrogen, etc. that condense at an even lower temperature than minus 160 C. If the cooling agent does not condense at a lower temperature it is useless as agent. At the point of condensation there is no relation anymore between pressure and temperature and the cooling effect disappears. To maintain the standing wave, an energy adding unit 34 can by placed at one and of the resonator device 30. The energy adding unit 34 is preferably placed at the end of the resonator device 30 that is at the opposite end to the inlets C and D.

### Resonator Device Operated to Produce a Phase Change.

Suppose that water saturated air is injected into the resonator device 30 via inlet C and out through outlet D when the soundwave has a maximum pressure, see FIG. 5, The same air passes into the container 50 via openings A and B that open at a minimum pressure of the soundwave, whereby also the container 50 reaches a lower pressure. During one cycle air and water vapor enters the container 50. The water vapor has a partial volume. When this amount of water vapor collapses into water droplets, its partial volume almost totally disappears. Thus the pressure decreases further. If the pressure decreases when the wave already is at a pressure minimum, energy is added to the wave.

### Resonator Device Driven by a Phase Change and a Salt.

Suppose that air, saturated with water vapor is injected into the resonator device 30 via inlet C and out via outlet D when the sound wave has a maximum pressure, see FIG. 5. The same air passes into the container 50 via openings A and B that open at a minimum pressure of the sound wave, such that the container 50 reaches a lower pressure. During one cycle air and water vapor enters into the container 50. If a very small amount of a salt is injected into the container 50, condensation can take place principally without the need for a lower pressure. The salt reacts with the water vapor and the salt can be seen as a fuel for this unit. If a partial volume disappears under the right conditions, the wave is maintained and a certain lower pressure appears in the container 50. Generally, very small amounts of salt are sufficient to stimulate the conversion of large amounts of water. In some cases a few parts per million (ppm) are enough and this does not affect the taste of the extracted water.

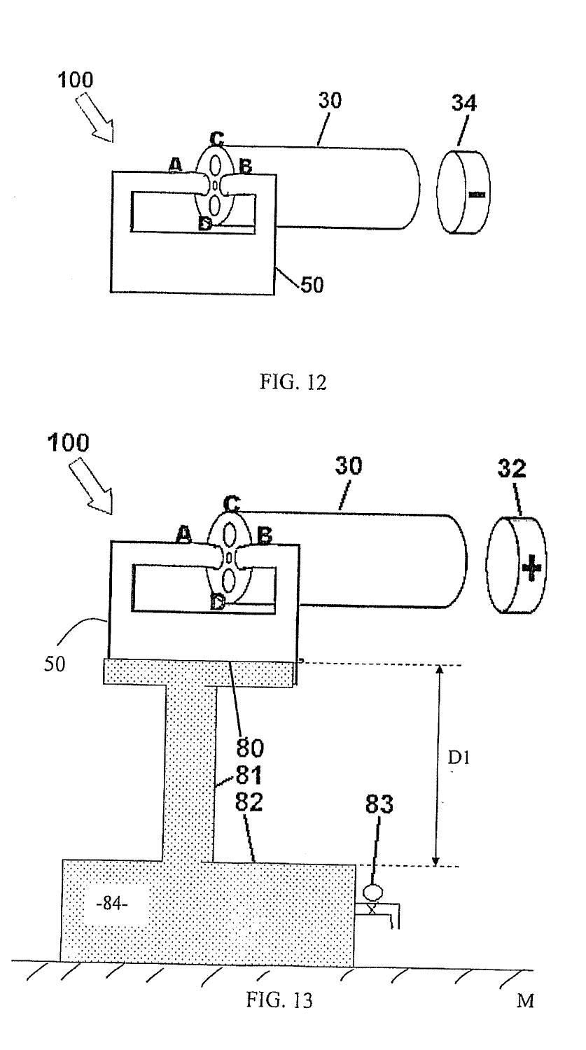

The generated energy can be taken out through an energy consuming unit 34 in the resonator device 30, see FIG. 12. The energy consuming unit 34 can for example consist of a piston and a crankshaft.

In FIG. 14, an embodiment of the arrangement 100 according to the invention contains a space 30 characterized by a separating plane 72 and an energy adding unit 32 and/or an energy consuming unit 34. Furthermore the arrangement 100 has a supply pipe (36 in FIG. 6) adjoined to the space 30. With the separating plane 72 the space 30 is divided into two connected parts 30a,30b, arranged to function as two resonators. Because of the separating plane the turbo unit 75 will force the gas efficiently through to the container 50.

The present invention has been described referring to exemplified embodiments, but it should be understood that the invention is not limited by these embodiments. They are only intended to illustrate the invention. For example, embodiments can be combined and it shall also be understood that embodiments of the arrangement 100 can include one or several resonator devices 30, arranged in several steps for example to obtain a bigger pressure swing and a better phase conversion. The invention has been described with reference to embodiments where an injected composition, for example a gas is condensed, but it shall also be understood that the injected composition can be in the state of a liquid or a solid and that other phase conversions than condensation can take place. The present invention is only limited by the enclosed claims.

1. An arrangement for phase conversion, wherein;
a space containing a working gas and arranged to contain a generated standing or traveling sound wave, whereby said sound wave is generated under the condition that added and/or consumed wave energy is greater than or equal to zero;
a valve mechanism for provision and outflow of an amount of a composition, consisting of at least one substance, that shall undergo a phase change and a working gas to the space and arranged to work synchronously with the generated sound wave, and such that;
the generated sound wave exposes the working gas and the added amount of composition to pressure and temperature changes, whereby a gas compression creates an increased temperature and a gas decompression creates a reduced temperature; and whereby a part of said added composition will undergo a phase change.

2. The arrangement according to claim 1, comprising at least one energy adding device and/or an energy consuming device arranged to add and/or consume acoustical wave energy so that the total sum of added and/or consumed wave energy is greater or equal to zero.

3. The arrangement according to claim 1, comprising the condensation or chemical reaction taking place in the space, whereby an acoustical wave energy is added and consumed so that the total sum of added and consumed wave energy is greater or equal to zero.

4. The arrangement according to claim 1, wherein the valve mechanism is arranged to open a first valve opening at a pressure maximum or a pressure minimum of the sound wave, whereby an amount of said working gas and said composition is added to the space.

5. The arrangement according to claim 4, wherein the space is arranged to allow for the outflow of the amount of said working gas and said composition to the atmosphere, when first mentioned valve opening is open.

6. The arrangement according to claim 1, wherein a container is arranged in connection with the space and that said valve mechanism is arranged to open a second valve opening at a pressure maximum or a pressure minimum of the sound wave, whereby a working gas and composition exchange will take place between the working gas and composition situated in the space and the working gas and composition situated in the container, and whereby the container reaches the same pressure as the pressure present in the space, when the second valve opening is open, and whereby a part of said added amount of working gas and composition that is added to the container will undergo a phase change in the container.

7. The arrangement according to claim 6, wherein the container contains a catalyst, for example a salt to speed up the phase change.

8. The arrangement according to claim 1, wherein said valve mechanism has a static disc with a number of holes and a rotating disc with a number of holes, whereby said valve mechanism is open when the holes of the rotating disc coincide with the holes of the static disc.

9. The arrangement according to claim 8, wherein at least one of the holes of the rotating disc is an asymmetric hole.

10. The arrangement according to claim 8, wherein at least one of the holes of the static disc is an asymmetric hole.

11. The arrangement according to claim 8, wherein a drive unit and a drive rod are arranged to rotate said rotating disc in relation to said static disc and said space.

12. The arrangement according to claim 1, wherein the valve mechanism consists of two separate working valve parts.

13. The arrangement according to claim 12, wherein the two separate working valve parts are arranged to open in an asymmetric way to facilitate said working gas and/or composition provision or outflow.

14. The arrangement according to claim 6, wherein a second container is arranged in connection with the container via a tube so that the second container, the tube and the container contain a condensate to a level in container.

15. The arrangement according to claim 14, wherein the distance D1 between level in the container to the upper surface of the second container is of the size range 1-100 meters, preferably 5 meters.

16. The arrangement according to claim 1, wherein space has the form of a cylinder, a funnel, a sphere or a toroid.

17. The arrangement according to claim 1, wherein the space has a diameter that varies along its length.

18. The arrangement according to claim 1, wherein the working gas is substantially comprised of air.

19. An arrangement according to claim 1, wherein said composition comprises a substance in gas form, for example water vapor that can undergo a phase change into water droplets.

20. The arrangement according to claim 1, wherein said composition includes air, methane, carbon dioxide, butane or propane that can undergo a phase change into a liquid or solid state.

21. The arrangement according to claim 1, wherein said composition comprises liquid drops that can undergo a phase change into a solid state, for example snow.

22. The arrangement according to claim 1, wherein said composition comprises a substance in a solid-state, for example snow that can undergo a phase change into water vapor.

23. The arrangement according to claim 2, wherein the energy adding device is a membrane, a piston arrangement, an engine, a salt or a volume reduction.

24. arrangement according to claim 1, wherein said space includes a separating plane, whereby space is divided into two connected parts along its length.
